(19) United States
(12) Patent Application Publication
(10) Pub. No.: US 2008/0141638 A1
(43) Pub. Date: Jun. 19, 2008

(54) Diesel Particle Filter with a Ceramic Filter Body

(75) Inventors: Jochen Linhart, Schwaikheim (DE); Karin Gerlach, Eningen (DE); Andreas Franz, Ludwigsburg (DE)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 11/945,371

(22) Filed: Nov. 27, 2007

(30) Foreign Application Priority Data
Nov. 27, 2006 (DE) 10 2006 056 196.1

(51) Int. Cl. B01D 46/52

(52) U.S. Cl. 55/520; 55/521

(57) ABSTRACT

A diesel particle filter having a ceramic filter body (1) made of a ceramic material (6) for filtering an exhaust gas stream (2) of a diesel engine. The filter body (1) has gas channels (18, 18′) with planar and porous filter segments (3), which are provided for the exhaust gas stream (2) to flow through them transversely to the face of the filter segments (3). The filter body (1) is formed by sintering at least one ceramic-impregnated fiber web (4), particularly paper, under heat such that fibers (5) of the fiber material are burned off and the ceramic material (6) is sintered together to form the continuously porous and gas-permeable filter segment (3) between its two surfaces (7, 8). At least one fiber web (4) is corrugated to form the gas channels (18, 18′) and rolled up to form the filter body (1), and the cross section of at least a portion of the gas channels (18, 18′) changes from an inlet end (33) to a discharge end (34).

### BACKGROUND OF THE INVENTION

The invention relates to a diesel particle filter with a ceramic filter body for filtering an exhaust gas stream of a diesel engine. The filter body has flat or solid segments and porous filter segments, which are provided to facilitate flow of the exhaust gas stream through the filter transversely to the face of the filter segments.

An exhaust gas filter for diesel engines is known from U.S. Pat. No. 4,704,863 (=DE 35 01 182). The ceramic filter bodies disclosed in that document comprise stacked planar and porous filter segments between which gas channels are formed. The gas channels are alternately closed. An exhaust gas stream flowing in on the side where the gas channels are open is forced by the plugs to flow through the porous filter segments, transversely to their faces. The exhaust gas channels on the opposite side are open in the discharge direction and release the filtered exhaust gas stream. This document gives no indication as to how the ceramic filter bodies disclosed therein are manufactured. Structurally comparable bodies, known for example from exhaust gas catalysts, are produced by extrusion. This requires high tooling costs for shaping. The extrusion process limits the degrees of freedom in the shaping of the filter body, particularly the filter segments and the gas channels. A flow-optimized design of the diesel particle filter is difficult to achieve.

US patent publication no. 2007/0186911 A1 (=WO 2006/005668) describes a ceramic exhaust gas filter for internal combustion engines having a filter body formed of ceramic-impregnated paper. A smooth or solid web and a corrugated impregnated paper web each are stacked into a semi-finished product to form gas channels and then rolled up into a wound filter body. The shape of the corrugations of the corrugated paper web is constant over the entire length of the web so that the gas channels also have a constant cross section along their running length.

### SUMMARY OF THE INVENTION

It is therefore an object of the invention to provide an improved diesel particle filter.

Another object of the invention is to provide a diesel particle filter which can achieve improved filtration at low cost.

These and other objects are achieved in accordance with the present invention by providing a diesel particle filter comprising a filter body formed of a ceramic material for filtering an exhaust gas stream of a diesel engine, wherein the filter body has gas channels with planar and porous filter segments, which are provided for crossflow of the exhaust gas stream transverse to the face of the filter segments, wherein the filter body is formed by sintering at least one ceramic-impregnated fiber web under heat such that fibers of the fiber web are burned off and the ceramic material is sintered together to form the continuously porous and gas-permeable filter segment between its two surfaces, wherein at least one fiber web is corrugated to form gas channels and is stacked in a plurality of superimposed layers to form the filter body, and wherein the cross section of at least a portion of the gas channels changes from an inflow side to an discharge side.

The invention thus relates to a diesel particle filter with a ceramic filter body made of a ceramic material, such that the filter body is formed of at least one ceramic-impregnated web of a fiber material, particularly paper, by sintering under heat so that the fibers of the fiber material are burned off. The ceramic material is sintered together, forming the continuously porous and gas permeable filter segment between its two surfaces. At least one fiber web is corrugated to form the gas channels and stacked in several layers to form the filter body. The term corrugation as used herein includes not only corrugations with a rounded, e.g., sinusoidal cross section, but also with an angular, e.g., triangular, rectangular or trapezoidal cross section. Any suitable, including an irregular, corrugation that forms the cross sections of the gas channels by an up and down progression may be provided.

The cross section of at least a portion of the gas channels changes from an inlet side toward a discharge side of the filter. This configuration of a variable channel cross section, which cannot be obtained using the extrusion process known in the prior art, becomes possible only with the use of a ceramic-impregnated fiber material. The volume flow of the exhaust gas stream flowing through the gas channels changes over the running length because a portion of the volume flow passes successively through the filter segments. This fact can be taken into account by changing the channel cross section along its running length. An almost arbitrary suitable pressure profile can be established in the exhaust gas stream along the running length to maximize the uniformity of the flow through the filter segments in all areas. Overall, the loading of the filter material is at least approximately uniformly distributed over its surface so that no local pressure peaks and therefore no localized areas of increased particle deposition occur.

The cross section of the inlet gas channels preferably narrows from the inlet end toward the discharge end. The cross section of the discharge gas channels preferably widens from the inlet end toward the discharge end. Particularly in a linearly varied cross-sectional progression, the flow rate along the running length of the gas channels and the pressure drop across the filter segments are at least approximately constant. Thus, the filtration loading of the individual filter segments is at least approximately constant over their entire surface, and the flow resistance is reduced. Maintenance intervals or intervals between burn-off cycles are extended.

In one preferred embodiment, the height of the gas channels is constant in a radial or stacking direction. This makes it possible to wind a continuous semi-finished product into a cylindrical filter blank. The same total cross section is available on the inlet side and the discharge side, which helps minimize the flow resistance and the associated pressure drop.

In an advantageous further embodiment, the corrugated fiber web is one-dimensionally curved. In such a one-dimensional curvature, each point of the corrugated fiber web lies on a line extending within the fiber web from the inlet end to the discharge end. This corrugation can be produced by simply bending the fiber web and does not require any expansion or compression in the fiber web plane. The necessary deformation forces and material loading are low. However, multidimensional shaping may also be advantageous to achieve irregular cross-sectional progressions of the flow channels, such that the fiber web is expanded or compressed in its plane within permissible limits while crease formation is avoided.

The corrugated fiber webs can be stacked flat on top of each other and are preferably rolled into a wound filter body. The use of ceramic-impregnated fiber webs enables formation of almost any desired shape. In the impregnated but unsintered state, the fiber webs maintain the shape of the basic filter body formed from them. The dimensional stability in this state is sufficient to produce even complex shapes with thin channel cross sections and thin wall thicknesses. During the sintering process, the fibers of the fiber webs burn out to produce the desired continuous porosity of the filter segments. In contrast to the extrusion process known in the prior art, this makes it possible to produce thinner wall thicknesses and almost any desired channel cross sections or cross-sectional progressions. Many more separate channels can be provided for the same inlet cross section. The pore size can be adjusted by using different fiber materials or ceramic impregnations. The diesel particle filters according to the invention are subject to substantially less pressure loss during flow through them for a given filtration effect.

It may for example be advantageous to form the filter body exclusively from corrugated fiber webs. In a preferred further embodiment a corrugated and a smooth or solid fiber web are alternately superimposed in relation to the layer arrangement to form the layered filter body. In particular, a semi-finished product can be provided which is formed of a corrugated fiber web and a smooth or solid fiber web adhering thereto, with the semi-finished product rolled or stacked into a filter body blank. The alternate arrangement of flat and corrugated fiber webs ensures that the individual gas channels of the diesel particle filter have a precisely defined cross section.

Depending on the filtration requirements to be met, it may be advantageous to have a tangential and/or radial flow through the filter segments. In one preferred embodiment the filter segments are formed by the corrugated fiber web. The ceramic material of the flat fiber web is preferably at least approximately gas-impermeable, or has reduced gas permeability, in the sintered state. This creates a substantially tangential flow through the filter segments, making it possible to ensure that flow and filtration conditions at the individual filter segments are at least approximately uniform over the entire filter cross section.

Adjacent gas channels are preferably alternately closed at the inlet end or at the discharge end. The gas channels closed at the discharge end represent inlet gas channels, whereas the gas channels closed at the inlet end are discharge gas channels. This alternate closure has the effect of blocking the oncoming gas flow, thereby forcing the oncoming exhaust gas to pass through the porous filter segments. The gas channels closed at the inlet end and open toward the discharge end ensure a precisely defined discharge of the filtered exhaust gas.

The gas channels may, for example, be closed by pushing in or crimping the corrugated fiber webs at an appropriate point, optionally supported by gluing. In one preferred further embodiment, plugs of ceramic material are provided to close the gas channels, such that the plugs and the fiber web are sintered together, for example into a monolithic body. The ceramic-impregnated fiber material makes it possible to produce very small channel cross sections, so that only very small plugs are required. This creates a filter body formed of a homogeneous material. If additional fastening materials for the plugs are eliminated, the filter can be exposed to high temperature loads without thermal cracking.

In one advantageous further embodiment, at least one fiber web has non-impregnated segments to form openings in the filter body. These non-impregnated segments of the filter web burn away during the sintering process. In the absence of ceramic impregnation, openings remain at these points, allowing, for example, an unhindered gas exchange between two adjacent gas channels. This makes it possible to use the flow cross section of all the gas channels for turbulence or for catalytic exhaust gas treatment, for example, e.g., in the inlet or discharge area, either before or after the adjacent plug.

### BRIEF DESCRIPTION OF THE DRAWINGS

The invention will be described in further detail hereinafter with reference to illustrative embodiments shown I the accompanying drawing figures, in which:

FIG. 1 is a schematic perspective view of a ceramic filter body according to the invention formed of ceramic-impregnated, rolled up and sintered fiber webs, for use in a diesel particle filter;

FIG. 2 is a schematic longitudinal section of two adjacent gas channels with an opening therebetween to allow unimpeded gas exchange;

FIG. 3 is a schematic view of a rolling and application unit for impregnating fiber webs with ceramic material and shaping and joining them into a semi-finished product;

FIG. 4 is an enlarged schematic detail view of the semi-finished product depicted in FIG. 3 showing gas channels with a variable cross section and details of a joint between a corrugated impregnated fiber web and a flat impregnated fiber web to form the gas channels, and

FIG. 5 is a schematic perspective view of a fiber web partly impregnated and provided with cutouts using the unit depicted in FIG. 3.

### DETAILED DESCRIPTION OF PREFERRED EMBODIMENTS

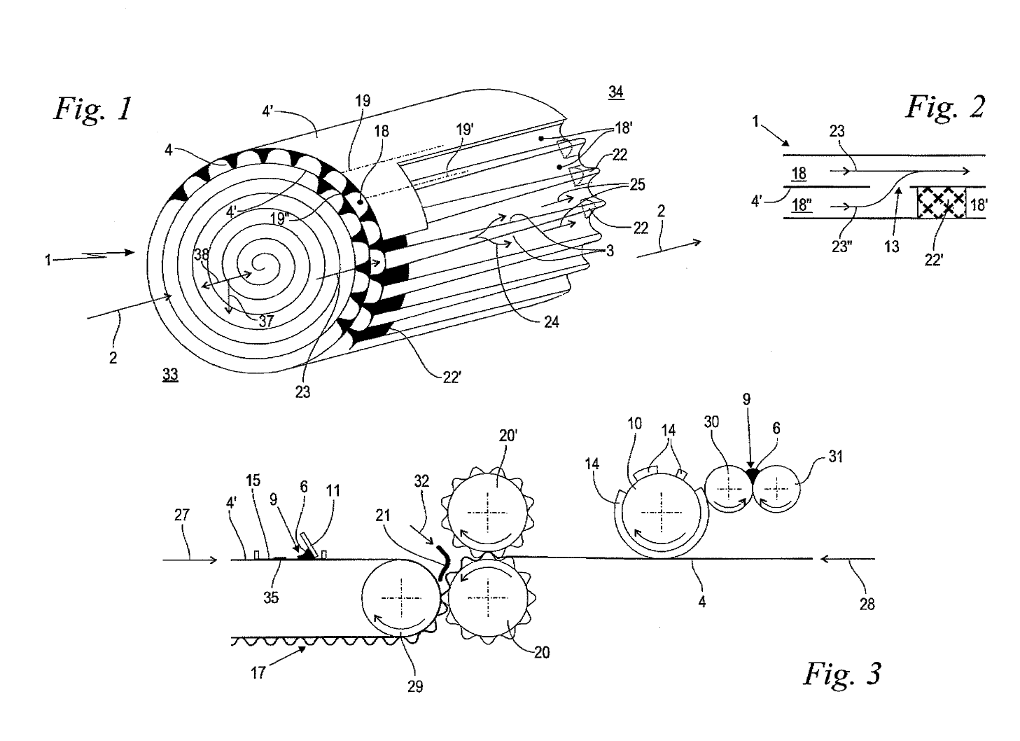

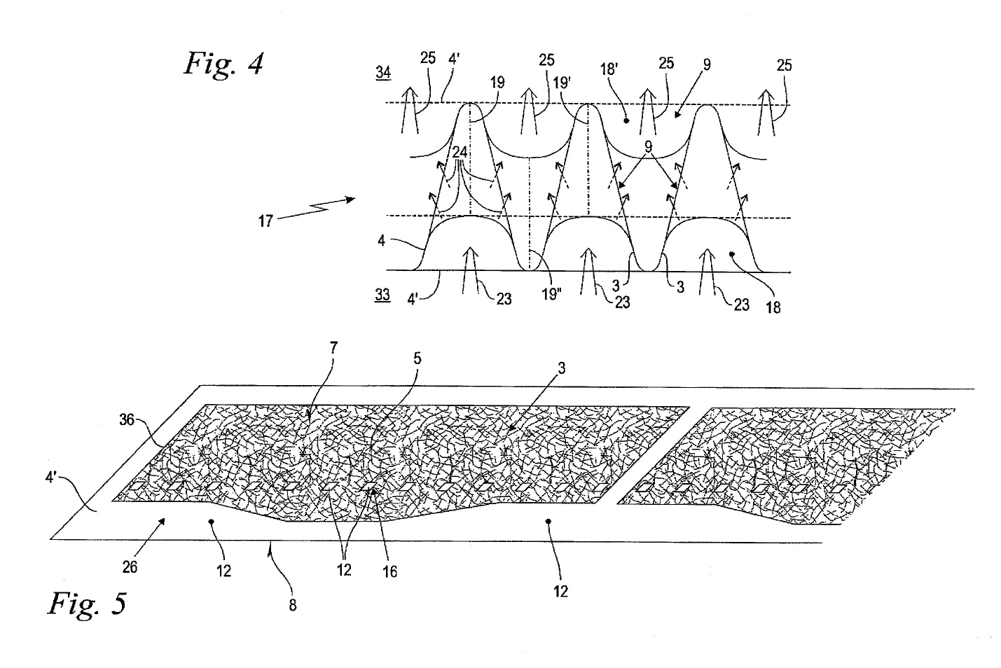

FIG. 1 is a schematic, partially cutaway perspective view of a ceramic filter body 1 according to the invention. The filter body 1 is part of a diesel particle filter provided to filter an exhaust gas stream 2 of a diesel engine, which is not shown here. The filter body 1 is formed of ceramic-impregnated fiber webs 4 and 4′, which are described in more detail below with reference to FIGS. 3 to 5. The fiber webs 4 and 4′ are joined to form a semi-finished product 17 as shown in FIGS. 3 and 4, which is rolled up to form an approximately cylindrical filter body 1. Rolling up the ceramic-impregnated fiber webs 4 and 4′ to form a wound filter body creates a layer direction which is identical to the radial direction 37 of the cylindrical filter body 1. Alternatively, it may also be advantageous to arrange a plurality of corrugated fiber webs 4 or semi-finished products 17 (FIGS. 3 and 4) in one plane and layer them in a stack.

The filter body 1 is designed for the exhaust gas stream 2 to flow through it in an axial direction 38 of the filter body 1 from an inlet end 33 to an discharge end 34. For this purpose, the first fiber web 4 is corrugated and the second fiber web 4′ is substantially flat or smooth. As used herein, the term “corrugation” includes corrugations with both rounded, e.g., sinusoidal, and angular, e.g., triangular, rectangular or trapezoidal cross sections. Due to the stacking or the wound structure, a corrugated fiber web 4 and a smooth fiber web 4′ are alternately superimposed relative to the radial direction 37 of the wound cylindrical filter body 1.

The corrugated fiber web 4 is joined to the second, smooth fiber web 4′ along a plurality of at least approximately parallel contact lines 19, 19′, 19″. The corrugation of the fiber web 4, the smooth shape of the additional fiber web 4′ and the wound structure create a plurality of at least approximately axially parallel gas channels 18, 18′, whose height as measured in the radial direction 37 is constant along the axial direction 38 of the filter body. A gas channel 18 and a gas channel 18′ are alternately provided in circumferential direction of the filter body 1. The gas channels 18 are open toward the inlet end 33 and closed by plugs 22 at the opposite or discharge end 34. In relation to the circumferential direction, a gas channel 18′, which is closed by a plug 22′ at the inlet end 33 and open toward the discharge end 34, lies between two gas channels 18.

In operation, the exhaust gas stream 2 flows axially parallel into the gas channels 18 which are open toward the inlet end 33 as indicated by arrow 23. Sidewalls of the ceramic structure produced by the corrugated fiber web 4 form solid and porous filter segments 3. The exhaust gas stream 2, the direct onward flow of which is blocked up by the plugs 22, is diverted in circumferential direction as indicated by arrow 24 and flows through the porous ceramic filter segments 3 transversely to their surface.

As indicated by arrows 24, the exhaust gas stream 2 passes through the filter segments 3 into the channels 18′, which are open toward the discharge end 34, and flows out of these channels as indicated by arrows 25. As the exhaust gas stream 2 passes through the porous filter segments 3, the diesel particles, etc. entrained in the exhaust gas stream are filtered out.

For certain applications it may be useful to provide openings 13 in the filter area formed by the solid or smooth fiber web 4′, the production of which is described below. The schematic longitudinal section of FIG. 2 shows such an opening 13 arranged upstream of a plug 22′, for example. The inlet gas channel 18 extends continuously past the plug 22′. The adjacently arranged channel structure is divided by the plug 22′ into the discharge gas channel 18′ and an inlet channel segment 18″.

The exhaust gas stream 2 (FIG. 1) can flow into the filter body 1 upstream of the plug 22′ using the flow cross section of the gas channels 18 and the channel segments 18″. In this region, e.g., a catalytic coating may be provided using the entire flow cross section. Upstream of the plug 22′ the exhaust gas from channel segment 18″ is diverted through the opening 13 into the inlet gas channel 18 as indicated by arrow 23″. There it is combined with the gas stream indicated by arrow 23, resulting in the filtration function described above.

Openings 13 may similarly be provided downstream of the plug 22 (FIG. 1). It may also be advantageous to provide such openings 13 in the filter region formed by the corrugated fiber web 4. Another advantageous option is to allow the exhaust gas to flow not only in axial direction 38 and circumferential direction indicated in FIG. 1, but also to flow through the channel walls the radial direction 37. In this case, the filter regions formed by the flat fiber web 4′ are also made porous and form filter segments through which the exhaust gas can flow radially.

FIG. 3 is a schematic representation of a device for producing the filter body 1 according to the invention (FIG. 1). Two feed rollers 30, 31 of the depicted unit are arranged axially parallel to each other and are set flush adjacent each other. They rotate in opposite directions, and the ceramic material 6 is stored in a wedge-shaped gap formed above their contact line. The ceramic material 6 may be a dry powder of finely ground ceramic, which is provided for dry impregnation of the fiber web 4. In the example shown, the ceramic material 6 is used to produce an aqueous emulsion 9. However, another suitable liquid or a liquid mixture may also be used instead of water. The ceramic material 6 is preferably aluminum oxide, cordierite, mullite, silicon carbide and/or aluminum titanate, which may either be used alone or in various combinations.

Another roller 10 is arranged axially parallel to the feed roller 30, which it contacts along a contact line. Because of its rotation, indicated by an arrow, the feed roller 30 carries the ceramic emulsion 9 to the roller 10 and rolls the ceramic emulsion 9 onto the surface of the roller 10. The roller 10 then rolls the ceramic material 6 into the material of the fiber web 4, which is guided underneath it as indicated by arrow 28. To this end, the roller 10 is pressed against the fiber web 4 with a contact pressure. The fiber web 4 is saturated with the emulsion 9. The flat, permeable fiber web 4 takes up the finely ground ceramic material 6 within its entire cross section.

The endless fiber web 4 then passes between two intermeshing corrugated rollers 20, 20′ set axially parallel to each other in the direction of arrow 28, giving the fiber web 4 impregnated with ceramic material 6 a corrugated shape. The corrugations of the corrugated rollers 20, 20′ are approximately mutually conical, so that the corrugations of the fiber web 4 also become mutually conical as shown in FIG. 4. That is to say, the corrugations are formed with a cross section which widens or narrows in the flow direction. The two corrugated rollers 20 and 20′ are heated. This causes the fiber web 4 impregnated with the emulsion 9 to dry slightly, but not thoroughly, so as to stabilize the corrugation.

Another fiber web 4′ is fed to the depicted device in the opposite direction, as indicated by arrow 27, and circulates around a pressure roller 29. A screen 15 contacts the fiber web 4′ in front of the pressure roller 29 as seen in the moving direction indicated by arrow 27. Above the screen 15 is stored an aqueous emulsion 9 with the ceramic material 6. The emulsion 9 is applied to the material of the fiber web 4′ by a squeegee 11 through the screen under pressure to saturate the fiber web 4′ with the emulsion 9. Alternatively, the fiber web 4′ may be dry-impregnated with the ceramic material 6. It may also be advantageous to impregnate the fiber web 4′ using a roller arrangement 10, 30, 31 like the one used for the opposite fiber web 4. Likewise, the corrugated fiber web 4 may advantageously be impregnated using a screen 15 and a squeegee 11.

The pressure roller 29 contacts the lower corrugated roller 20. Because of the opposing rotation of the pressure roller 29 and the corrugated roller 20, the flat fiber web 4′ and the corrugated fiber web 4 are pressed and joined together. Behind the roller arrangement 29, 20 as seen in the feed direction, is produced a semi-finished product 17, which will be described in more detail with reference to FIG. 4.

FIG. 4 is an enlarged schematic detail view of the semi-finished product 17 illustrated in FIG. 3. The corrugation peaks of the corrugated fiber web 4 contact the smooth fiber web 4′ located above it along contact lines indicated by broken lines 19, 19′ and is bonded thereto along the contact lines 19, 19′. If desired, this bond may be produced using a suitable adhesive. In the illustrated embodiment the bond is produced by the ceramic emulsion 9 in the fiber webs 4, 4′. It may also be advantageous to apply additional ceramic emulsion 9 along the contact lines 19, 19′, optionally in a thickened form, to obtain a bond between the two fiber webs 4 and 4′. In the bonded state of the semi-finished product 17, the subsequent gas channels 18, 18′ are preformed by the corrugation structure of the corrugated fiber web 4 and the smooth form of the flat fiber web 4′, so that the sidewalls of the corrugated fiber web 4 are provided for forming the subsequent filter segments 3.

The semi-finished product 17 saturated with the ceramic emulsion 9, when it is still in its moist state, i.e., when the emulsion 9 has not yet thoroughly dried, is wound or rolled into the shape of the subsequent filter body 1 depicted in FIG. 1, or is stacked, and then dried. During winding or stacking, corrugation valleys of the corrugated fiber web 4 are bonded to the underlying flat fiber web 4′ along contact lines 19″, so that not only the gas channels 18, but also the additional gas channels 18′, are closed in the radial and circumferential directions of the approximately cylindrical filter body 1 (FIG. 1). The bond along the contact lines 19″ is formed in the same manner as that along the contact lines 19, 19′.

After the drying process, the resulting filter blank is sintered under heat in a sintering furnace, so that the ceramic material 6 is sintered together to form a monolithic ceramic body. At the high sintering temperature, the material of the fiber webs 4, 4′ burns away completely, so that a specific porosity of the ceramic material 6 is obtained. The porosity is such that the exhaust gas stream 2 (FIG. 1) can flow through the ceramic filter segments 3, transversely to the faces thereof.

The cross section of the gas channels 18, 18′ changes along the axial direction 38. The cross section of the inlet gas channels 18 narrows from the inlet end 33 toward the discharge end 34. Conversely, the cross section of the discharge gas channels 18′ widens from the inlet end 33 to the discharge end 34, but the channel height of all the gas channels 18, 18′ remains constant. This is achieved by forming the the corrugations of the fiber web 4 with wide corrugation peaks at the inlet end 33 and narrow corrugation peaks at the discharge end 34. In the embodiment shown, the width of the corrugation peaks decreases linearly from the inlet end 33 to the discharge end 34.

Because the channel height remains constant and the fiber web 4 has a one-dimensional, approximately conical curvature, the progression of the cross section is also approximately linear. A different, non-linear progression, obtained particularly by a multidimensional spatial curvature of the fiber web 4, may, however, also be useful. Alternatively, a corrugation structure in which the cross section of the gas channels 18, 18′ is approximately constant from the inlet end 33 to the discharge end 34 may also be advantageous.

The exhaust gas stream 2 entering the gas channels 18 along arrows 23 (FIG. 1) passes through the filter segments 3 as indicated by arrows 24 along the entire running length of the gas channels 18, 18′. This reduces the oncoming volumetric flow 23 in gas channel 18 along the channel's running length, while the discharge volumetric flow 25 in gas channel 18′ progressively increases along that channel's running length.

The above-described cross-sectional progression of the gas channels 18, 18′ has the result that the flow rate within the gas channels 18, 18′ and the pressure differential between the gas channels 18, 18′ as measured across the filter segments 3 are at least approximately constant along the channels' running length. The filtration load of the filter segments 3 is therefore at least approximately constant along the running length of the gas channels 18, 18′. With regard to the other features and reference numerals, the embodiment illustrated in FIG. 4 corresponds to that of FIG. 1.

FIG. 5 is a schematic perspective view of the endless fiber web 4′. The description below applies analogously also to the other fiber web 4 (FIG. 3). The fiber webs 4 and 4′ are comprised of fibers 5. A non-woven fabric or knit fabric may be provided for this purpose. An open, permeable filter paper is preferred. The fiber web 4′ is planar and permeable in the sense that the finely ground ceramic material 6 (FIG. 3) can penetrate between fibers 5 of the fiber web 4. The permeability of the fiber web 4 and the impregnation process illustrated in FIG. 3 are adjusted to each other so that after impregnation with the ceramic material 6 (FIG. 3), some of the fibers 5 are exposed on the two opposite surfaces 7, 8 of the fiber web 4.

When the fibers 5 are burned off during the sintering process, this has the result that the sintered ceramic filter segment 3 is porous throughout from a surface 7 to the opposite surface 8 and therefore gas-permeable for the exhaust gas stream 2 (FIG. 1) transversely to the face of the filter segment 3.

For certain applications it may be useful to produce a reduced porosity, at least in sections, and therefore at least approximate gas impermeability. For example, the porosity of the filter body 1 (FIG. 1) can be so low in the region of the smooth fiber web 4′ that, technically, in terms of the filtration process, it is practically gas-impermeable, and a noticeable gas permeability is desired only in the region of the corrugated fiber web 4. In this case, the fiber web 4 is subjected not only to a saturating impregnation but also a closed surface coating with the ceramic material 6 (FIG. 3) on at least one of the two surfaces 7, 8, so that no fibers 5 are exposed there. In this case, a closed ceramic body is created during sintering which is barely porous in the region of the surface 7, 8 and therefore essentially gas-impermeable in a technical sense. The adjustment of the gas permeability and gas impermeability may also be accomplished or supported by a corresponding adjustment of the ceramic material 6.

It may be advantageous to impregnate the fiber webs 4, 4′ as uncut endless material over their full area with ceramic material 6 (FIG. 3). Non-impregnated sections 12 can be formed by stamping cutouts 16, for example, to subsequently form openings 13 (FIG. 2) or by cutting a limited planar form 36 along its margin 26. The embodiment shown in FIG. 5 has non-impregnated sections 12, which are selectively excluded from impregnation with the ceramic material 6. One portion of the non-impregnated sections 12 is omitted from impregnation to form subsequent openings 13 (FIG. 2). Another non-impregnated section 12 is formed by the margin 26 surrounding the limited planar form 36. The limited planar form 36 has the contour necessary to roll up the filter body 1 shown in FIG. 1. The planar form 36 may be produced by cutting the fiber web 4, particularly by stamping the circumferential contour of the planar form 36 and stamping out the cutouts 16. It may also be advantageous not to stamp out the cutouts 16 and only to exclude the associated sections 12 from impregnation with the ceramic material 6 (FIG. 3). This is accomplished as described below. The fiber webs 4, 4′ that are only partly impregnated and/or cut are joined to form the semi-finished product 17 as described above, which is then formed into the blank of the filter body 1 illustrated in FIG. 1. In this process, the impregnated regions of the fiber webs 4 and 4′ assume the shape of the filter body 1 being formed (FIGS. 1 and 2). In the subsequent sintering process, the uncut and non-impregnated sections 12 burn completely away and leave the filter body 1 in the form shown in FIGS. 1 and 2, including the openings 13 (FIG. 2).

It may be seen from FIG. 3 that the roller 10 has a surface structure 14. The shape of this structure corresponds to the contour of the planar form 36 illustrated in FIG. 4. The ceramic emulsion 9 is rolled into the fiber web 4 under pressure only by the elevated surfaces of the surface structure 14. In the intermediate, radially recessed areas of the surface structure 14, no impregnation with ceramic material 6 can occur, so that the fiber web 4, analogous to the fiber web 4′ shown in FIG. 5, is only partially impregnated with the ceramic material 6 such that non-impregnated sections 12 are formed.

An alternative method of producing non-impregnated sections 12 in the fiber web 4′ can be seen from FIG. 3 in the region of the screen 15. In this method, similar to screen printing, the screen 15 has covers 35, which are depicted schematically. The contours of the covers 35 correspond to the non-impregnated sections 12 shown in FIG. 5. As the ceramic emulsion 9 is applied under pressure by the squeegee 11, the covers 35, optionally also the stampings or cutouts 16 (FIG. 5), prevent saturation in part and form the non-impregnated sections 12.

It may furthermore be seen from FIG. 3 that, prior to joining the two fiber webs 4 and 4′, beads 21 of ceramic material are applied to the corrugated fiber web 4 as indicated by arrow 32. The ceramic beads 21 are squeezed between the two fiber webs 4, 4′ and subsequently form the plugs 22 and 22′ shown in FIG. 1. In order to achieve the alternate arrangement of the plugs 22 and 22′ illustrated in FIG. 1, it may be useful to apply the beads 21 intermittently. For certain applications it may also be useful to dispose the plugs 22, 22′ continuously in circumferential direction, such that the associated beads 21 are also applied continuously. The beads 21 consist of a moist, soft ceramic material and are dried together with the fiber webs 4 and 4′ and then sintered, so that a monolithic ceramic filter body 1 is produced as shown in FIG. 1.

In the embodiment shown, the impregnation of the fiber webs 4 and 4′ with the ceramic material 6 (FIG. 3) is done first, before the corrugation of the fiber web 4, the joining to form the semi-finished product 17 and the rolling up to form the blank of the filter body 1 depicted in FIG. 1. This blank is then dried and finally sintered. It may also be advantageous first to cut and shape the blank of the filter body 1 depicted in FIG. 1 from non-impregnated fiber webs 4 and 4′ in the manner described above and only then to saturate it with the ceramic material 6 (FIG. 3), e.g., in a dipping bath. A drying process and finally the sintering process are carried out thereafter.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A diesel particle filter comprising a filter body formed of a ceramic material for filtering an exhaust gas stream of a diesel engine, wherein the filter body has gas channels with porous filter segments through which the exhaust gas stream can flow transversely to the face of the filter segments, wherein the filter body is formed by sintering at least one ceramic-impregnated fiber web under heat such that fibers of the fiber web are burned off and the ceramic material is sintered together to form the continuously porous and gas-permeable filter segment between its two surfaces, wherein at least one fiber web is corrugated to form gas channels and is stacked in a plurality of superimposed layers to form the filter body, and wherein the cross section of at least a portion of the gas channels changes from an inlet end to a discharge end.

2. A diesel particle filter as claimed in claim 1, wherein the cross section of the inlet-side gas channels converges from the inlet end to the discharge end.

3. A diesel particle filter as claimed in claim 1, wherein the cross section of the outlet-side gas channels diverges from the inlet end to the discharge end.

4. A diesel particle filter as claimed in claim 3, wherein the gas channels have a constant radial height.

5. A diesel particle filter as claimed in claim 1, wherein the corrugated fiber web is one-dimensionally curved.

6. A diesel particle filter as claimed in claim 1, wherein the stack of the at least one fiber web is formed by winding it into a wound filter body.

7. A diesel particle filter as claimed in claim 1, wherein, the stacked filter body is constructed of stacked corrugated fiber webs and smooth fiber webs alternately superimposed on each other in a stacking direction.

8. A diesel particle filter as claimed in claim 1, wherein the filter segments are formed by the corrugated fiber web, and the ceramic material of the flat fiber web is gas impermeable in the sintered state.

9. A diesel particle filter as claimed in claim 1, wherein adjacent gas channels are alternately closed at an inlet end or at a discharge end.

10. A diesel particle filter as claimed in claim 9, wherein the alternately closed channels are closed by plugs formed of ceramic material.

11. A diesel particle filter as claimed in claim 1, wherein at least one fiber web has non-impregnated sections forming openings in the filter body.

12. A diesel particle filter as claimed in claim 1, wherein the at least one fiber web is a paper web.
